(19) United States
(12) Patent Application Publication
(10) Pub. No.: US 2006/0050508 A1
(43) Pub. Date: Mar. 9, 2006

(54) Luminous A/V cable assembly

(76) Inventors: Chang-Chi Lee, Yun-Lin Shian (TW); Jay Victor, Yun-Lin Shian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/936,474

(22) Filed: Sep. 9, 2004

(51) Int. Cl. B60Q 1/26

(52) U.S. Cl. 362/227

(57) ABSTRACT

The present invention relates to a luminous A/V cable assembly. The luminous A/V cable assembly comprises an A/V transmission line and a power line, wherein a plurality of light bulbs is connected to the power line; the plurality of light bulbs is connected in series to define a light bulb group, or using in series and(or) in parallel or any combination of in series and in parallel connecting method; the A/V transmission cable and the power cable being connected to the plurality of light bulb groups are clad with a plastic material to constitute an A/V cable having an overall different colored luminous effect.

### BACKGROUND OF THE INVENTION

1. Field of the Invention

The present invention relates to a luminous A/V (audio/video) cable assembly, and particularly to a luminous A/V cable assembly extensively used for cables such as a microphone cable, a guitar cable, a stage cable and a sound box connection cable.

2. Description of the Related Art

The development of audio and video technology has imposed higher personal requirements for connection cables of relevant equipments such that the connection cables for A/V equipments should have more additional functions on top of the basic functions. Generally, conventional microphone cable, guitar cable and stage cable have no other functions except the signal-transmitting function, and the external layer of these connection cables generally adopt a darker colored insulated plastic wrapping. Therefore, when the cable is used in a certain occasion, the position of these connection cables cannot be shown obviously; particularly when it is used in nighttime or at a performance stage with dim lighting, the working staffs or performers will stumble and get hurt, or step on the connection cable that will affect the quality of signal transmissions as well as the service life of the transmission cable.

To overcome the existing shortcomings of the prior-art products and make the application more convenient and practical, the inventor of the present invention based on years of professional experience to conduct extensive researches and developments to maximize the effects of the present invention, and finally invented a luminous A/V cable assembly.

### SUMMARY OF THE INVENTION

The objective of the present invention is to provide a luminous A/V cable assembly, which comprises an audio and video (A/V) transmission line and a power line. The power line is connected to a plurality of light bulbs, and these light bulbs are connected in series with each other to form a group of light bulbs, and the plurality of light bulb groups is connected in parallel with each other, or using in series and(or) in parallel or any combination of in series and in parallel connecting method, and the A/V transmission line and the power line are connected to the plurality of light bulb groups, which are clad by a plastic material to constitute a whole cable assembly.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a cross-sectional view of the luminous A/V cable assembly of the present invention.

FIG. 2 shows the schematic diagram of the light bulbs connecting structure of an embodiment of the present invention.

### DETAILED DESCRIPTION OF THE PREFERRED EMBODIMENTS

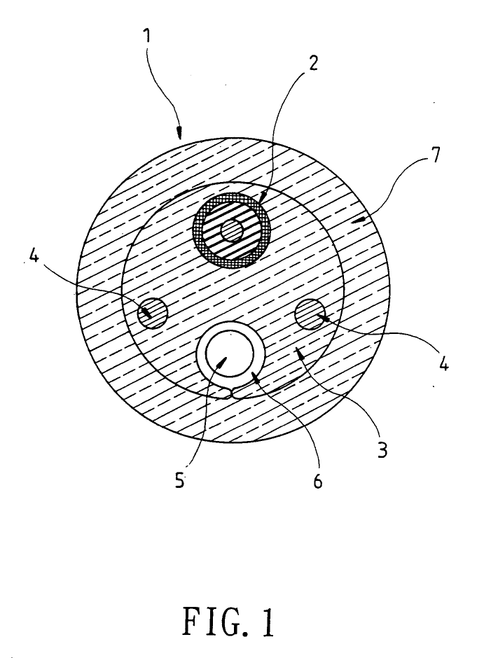

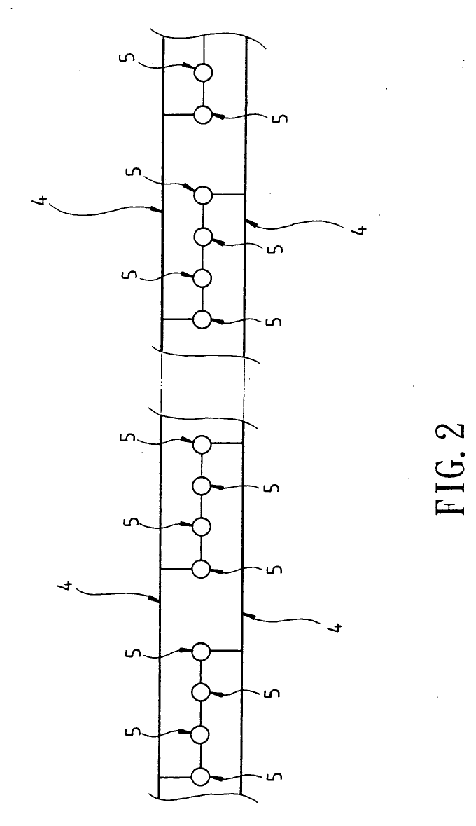

Referring to FIG. 1 for a luminous A/V cable assembly according to the present invention, the luminous A/V cable 1 comprises an A/V transmission line 2 for transmitting audio and video signals, and a power line 4 being coupled to a light bulb 5 as shown in FIG. 2. A plurality of light bulbs 5 is connected in series to define a group of light bulbs 5 and a plurality of groups of light bulbs 5 is connected in parallel. The A/V transmission line 2 and the power line connected to a plurality of light bulbs 5 are clad by a plastic sheath 7, and a filler 3 is filled in the gap of the sheath 7. The filler 3 has a bulb groove 6 for accommodating the light bulb 5 as to constitute an overall cable assembly.

The foregoing filler 3 and sheath 7 are pervious to light and made of a transparent or translucent plastic material or transparent or translucent plastic material tinted in any colors. The light bulb 5 could be a small bulb, an LED lamp or a neon light or any other electric type bulbs having various colors. The light bulbs 5 are extruded with the A/V line 2 and the power line 4, such that lights of different colors are emitted after the power line 4 is connected to a power supply. “Extrusion” means that thermoplastics (such as PE or PVC, etc.) or thermoset plastics are heated to a certain temperature and then extruded on a conductor or a core wire as to clad the conductor or core wire and define an insulation or a sheath. Extrusion here refers to the formation of a sheath, and cladding the A/V transmission line and the power line with plastics.

The basic principle of the present invention is that the A/V transmission line 2 and the power line 4 are co-extruded, and the A/V transmission cable 2 can be of different structures such as a coaxial cable assembly or a twisted-pair cable assembly. Different structures transmit different audio and video signals. If the A/V transmission cable is a coaxial signal cable, the coaxial cable could be a single or a multiple wires. With the selection of different colored light bulbs 5 and different colored transparent or translucent filler 3 and sheath 7, lights having different effects can be produced. The light bulbs are connected in series to define a group of light bulbs and then a plurality of groups of light bulbs is connected in parallel, or using in series and(or) in parallel or any combination of in series and in parallel connecting method.

The A/V transmission cable according to the present invention comprises a coaxial cable assembly, a shielded twisted-pair cable assembly, a non-shielded twisted-pair cable assembly and a multi-core twisted shielded cable assembly; and the shielded twisted-pair cable or non-shielded twisted-pair cable may comprise one pair or a plurality of pairs, and the external insulated shielding layer is optional and selected for use as needed.

Either a DC power or an AC power can be used for the small bulbs, LED lamps or neon lamps or any other electric type bulbs according to the present invention. A plurality of light bulbs such as small bulbs, LED lamps or neon lamps or any other electric type bulbs in different quantities is connected in series to adapt different voltage ratings and form a group of luminous sources. Through the parallel connection of a plurality of groups of luminous sources, it is possible to obtain luminous A/V connection cables of different lengths. Any other connecting method such as in series and (or) in parallel or any combination of in series and in parallel can be used. Further, the cross section of the transmission cable could be in a circular shape, an oval shape, or a polygonal shape or any other shapes.

In summation of the description above, the present invention definitely can meet the requirements of the original objectives and the invention herein enhances the performance than the conventional structure and further complies with the patent application requirements and is submitted to the Patent and Trademark Office for review and granting of the commensurate patent rights.

What is claimed is:

1. A luminous A/V cable assembly, comprising of: an A/V transmission line, for transmitting an A/V signal; and a power line, being coupled to a plurality of light bulbs, and said plurality of light bulbs being connected in series to define a light bulb group, and a plurality of light bulb groups being connected in parallel, or using in series and(or) in parallel or any combination of in series and in parallel connecting method; such that said A/V transmission line and said power line coupled to said plurality of light bulbs being clad into a plastic sheath, and a filler being filled into the gap of said plastic sheath and having a bulb groove for accommodating said light bulb to define a luminous A/V cable assembly.

2. The luminous A/V cable assembly of claim 1, wherein said filler and said cover are pervious to light and made of a material selected from the collection of a transparent plastic material and a translucent plastic material and transparent or translucent plastic material tinted in any colors.
